(19) United States
(12) Patent Application Publication
(10) Pub. No.: US 2026/0245854 A1
(43) Pub. Date: Aug. 20, 2026

(54) ANALYSIS APPARATUS

(71) Applicant: SHIMADZU CORPORATION, Kyoto-shi (JP)

(72) Inventors: Mao SHIOMI, Kyoto-shi (JP); Minoru OKUDA, Kyoto-shi (JP); Manabu UEDA, Kyoto-shi (JP); Takeshi UCHIDA, Kyoto-shi (JP); Tomoya KUDO, Kyoto-shi (JP); Fumihiko HIRATA, Kyoto-shi (JP); Hiroki MIYASHIRO, Kyoto-shi (JP); Ryo KAGEYAMA, Kyoto-shi (JP); Hiroki KANNEN, Kyoto-shi (JP)

(73) Assignee: SHIMADZU CORPORATION, Kyoto-shi (JP)

(21) Appl. No.: 19/451,547

(22) Filed: Jan. 16, 2026

(30) Foreign Application Priority Data
Feb. 14, 2025 (JP) 2025-022066

(51) Int. Cl. H01J 49/24; H01J 49/02

(52) U.S. Cl. CPC H01J 49/24; H01J 49/025

(57) ABSTRACT

An analysis apparatus includes: an ionization unit that generates ions by ionizing a sample; a vacuum chamber into which ions are introduced and an inside of which is maintained at a vacuum; a detector that detects the ions; and a small vacuum gauge 1 that measures the degree of vacuum of the vacuum chamber. The small vacuum gauge 1 includes a cylindrical CAN package, a substrate accommodated in the CAN package, and a vacuum degree sensor formed on the substrate.

### TECHNICAL FIELD

The present disclosure relates to an analysis apparatus.

### BACKGROUND ART

In analysis apparatuses such as mass spectrometers and ion analyzers, separation, detection, and the like of ions generated by ionizing a sample are performed in a vacuum chamber. A mass spectrometer disclosed in JP 2023-28190 A (Patent Literature 1) discloses a first vacuum chamber and a second vacuum chamber in which convergence of ions is performed, and an analysis chamber in which ions are separated and detected, and describes that each vacuum chamber is evacuated by a vacuum pump to be maintained at an appropriate degree of vacuum, respectively.

### Citation List

### Patent Literature

### Patent Literature 1 JP 2023-28190 A

### SUMMARY OF INVENTION

### Technical Problem

The degree of vacuum in a vacuum chamber is generally monitored using a Pirani gauge. A Pirani gauge is a vacuum gauge that measures the degree of vacuum by utilizing the fact that the current value flowing through a platinum wire changes when gas molecules collide with the platinum wire while a current is flowing through it. Therefore, by installing a Pirani gauge in a vacuum chamber or in a vacuum pipe connecting a vacuum chamber and a vacuum pump, the degree of vacuum of the vacuum chamber can be measured.

However, since a Pirani gauge requires a certain size due to its structure, the Pirani gauge provided in the vacuum chamber and the vacuum pipe may become a hindrance to miniaturizing the analysis apparatus.

The present disclosure has been made to solve such a problem, and an object thereof is to provide an analysis apparatus capable of measuring the degree of vacuum of a vacuum chamber and capable of miniaturization.

### Solution to Problem

An analysis apparatus according to one aspect of the present disclosure includes: an ionization unit that generates ions by ionizing a sample; a vacuum chamber into which the ions are introduced and an inside of which is maintained at a vacuum; a detector that detects the ions; and a small vacuum gauge that measures a degree of vacuum of the vacuum chamber. The small vacuum gauge includes a cylindrical CAN package, a substrate accommodated in the CAN package, and a vacuum degree sensor formed on the substrate.

### Advantageous Effects of Invention

According to the present disclosure, it is possible to provide an analysis apparatus capable of measuring the degree of vacuum of a vacuum chamber and capable of miniaturization.

### BRIEF DESCRIPTION OF DRAWINGS

FIG. 1 is a schematic configuration diagram of an analysis apparatus according to an embodiment.

FIG. 2 is a view of a small vacuum gauge before being installed in a vacuum chamber or a vacuum pipe, viewed from obliquely above.

FIG. 3 is a diagram showing an installation example of a small vacuum gauge.

FIG. 4 is a diagram showing an installation example of a small vacuum gauge.

FIG. 5 is a diagram for explaining the sizes of each of the small vacuum gauge and a Pirani gauge.

FIG. 6 is a diagram showing TYP values of a small vacuum gauge.

FIG. 7 is a diagram showing a graph of TYP values and output equations of a small vacuum gauge.

FIG. 8 is a diagram showing parameters of output equations of a small vacuum gauge.

FIG. 9 is a diagram showing the accuracy of small vacuum gauges before calibration.

FIG. 10 is a diagram showing the accuracy of small vacuum gauges after calibration.

### DESCRIPTION OF EMBODIMENTS

Hereinafter, embodiments of the present disclosure will be described in detail with reference to the drawings. In the drawings, the same or corresponding parts are denoted by the same reference numerals, and the description thereof will not be repeated.

### Configuration of Analysis Apparatus

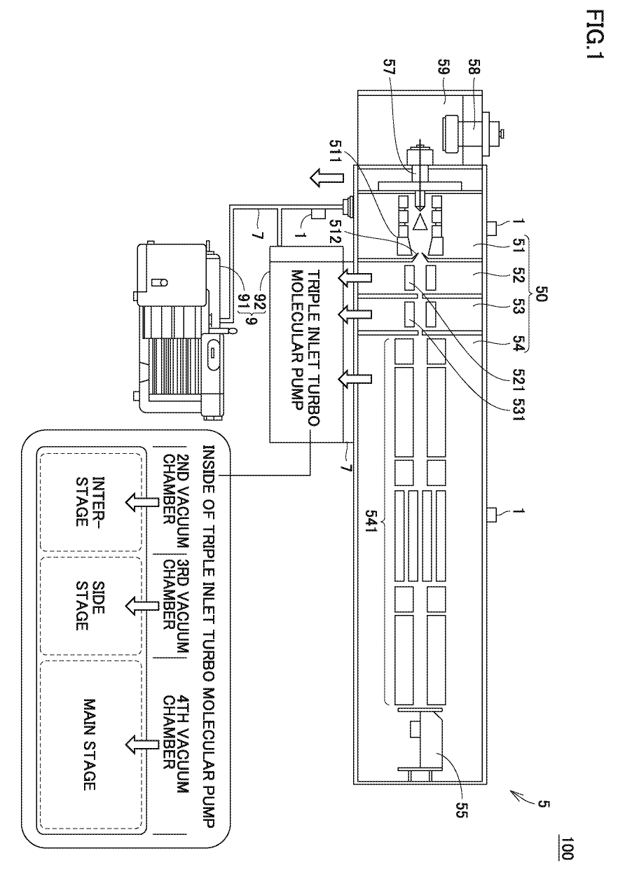

FIG. 1 is a schematic configuration diagram of an analysis apparatus 100 according to an embodiment. The analysis apparatus 100 is, for example, a mass spectrometer or an ion analyzer. More specifically, the analysis apparatus 100 is an analysis apparatus that utilizes the behavior of ions, molecules, etc., in a vacuum, such as an LC-MS (Liquid Chromatography Mass Spectrometry), an ICP (Inductively Coupled Plasma) emission spectrometer, or a helium (He) leak detector.

In one example, the analysis apparatus 100 is a mass spectrometer, and in a more specific example, it is an LC-MS.

The analysis apparatus 100 includes a small vacuum gauge 1 according to the embodiment, a main body 5, a vacuum pipe 7, and a vacuum pump 9. Note that the size ratio of each part in FIG. 1 differs from the actual size ratio.

The main body 5 is a part that performs analysis in the analysis apparatus 100. The main body 5 includes an ESI probe 58, an ionization chamber 59, a vacuum chamber 50, and a detector 55. The housing of the main body 5 is generally made of metal.

The ESI probe 58 generates ions by ionizing a sample in the ionization chamber 59. The ESI probe 58 corresponds to an example of an "ionization unit" [or "ionization device"]. In one example, the ESI probe 58 is an ESI probe with heating assist gas, which is frequently used in mass spectrometers.

The inside of the vacuum chamber 50 is maintained at a vacuum. Ions are introduced into the vacuum chamber 50 from the ionization chamber 59. In the vacuum chamber 50, the detector 55 detects the ions.

Hereinafter, the configuration of the main body 5 will be described in more detail. The ionization chamber 59 is at substantially atmospheric pressure. The vacuum chamber 50 includes a first vacuum chamber 51, a second vacuum chamber 52, a third vacuum chamber 53, and a fourth vacuum chamber (analysis chamber) 54, and each of the first vacuum chamber 51 to the fourth vacuum chamber 54 is evacuated by the vacuum pump 9. The analysis apparatus 100 has a configuration of a multi-stage differential pumping system in which the degree of vacuum sequentially increases from the ionization chamber 59 toward the first vacuum chamber 51, the second vacuum chamber 52, the third vacuum chamber 53, and the fourth vacuum chamber 54.

The ionization chamber 59 is provided with the ESI probe 58 as an ion source. The ESI probe 58 ionizes various components contained in the sample by spraying the sample as minute charged droplets into the ionization chamber 59. The ionization chamber 59 and the first vacuum chamber 51 communicate with each other through a small-diameter desolvation tube 57, and ions generated in the ionization chamber 59 are sucked into the desolvation tube 57 riding on a gas flow formed by a differential pressure between both ends of the desolvation tube 57. The desolvation tube 57 is heated to a predetermined temperature (for example, several hundred degrees), and when charged droplets in which the solvent is not sufficiently vaporized are sucked into the desolvation tube 57, vaporization of the solvent is promoted when passing through the desolvation tube 57, and ions are generated.

Ion guides 511, 521, and 531 are arranged in the first vacuum chamber 51, the second vacuum chamber 52, and the third vacuum chamber 53, respectively. A predetermined voltage is applied from a power supply unit (not shown) to each of a plurality of electrodes constituting the ion guides 511, 521, and 531, whereby an electric field for transporting ions while converging them is formed in a space surrounded by the plurality of electrodes. Sample-derived ions introduced into the first vacuum chamber 51 are converged by the ion guide 511 and sent to the second vacuum chamber 52 through a small hole provided at the top of a skimmer 512. Ions introduced into the second vacuum chamber 52 are converged by the ion guide 521 and sent to the third vacuum chamber 53. Ions introduced into the third vacuum chamber 53 are converged by the ion guide 531 and sent to the fourth vacuum chamber 54.

In the fourth vacuum chamber 54, a quadrupole mass filter 541 and the detector 55 are arranged along the ion optical axis. A predetermined voltage is applied from a power supply unit (not shown) to a plurality of rod electrodes constituting the quadrupole mass filter 541, whereby an electric field that selectively allows ions having a specific mass-to-charge ratio m/z (or included in a specific m/z range) to pass through and diverges other ions is formed. Among various ions introduced into the fourth vacuum chamber 54, for example, only ions having a specific m/z pass through the quadrupole mass filter 541 and reach the detector 55.

The detector 55 outputs an ion intensity signal corresponding to the amount of incident ions. This ion intensity signal is input to a data processing circuit (not shown), and data processing is performed in the data processing unit. In one example, the data processing circuit is a computer including a memory and a processor such as a CPU (Central Processing Unit). For example, when the voltage applied to the electrodes constituting the quadrupole mass filter 541 is scanned within a predetermined range, the m/z of ions that can pass through the quadrupole mass filter 541 changes. Thereby, the data processing unit can create a mass spectrum showing a change in ion intensity over a predetermined m/z range.

The vacuum pump 9 evacuates the vacuum chamber 50. The vacuum pump 9 includes a rotary pump 91 and a turbo molecular pump 92. The rotary pump 91 evacuates the entire vacuum chamber 50 from atmospheric pressure to a predetermined degree of vacuum. In one example, the turbo molecular pump 92 is a triple inlet turbo molecular pump. The turbo molecular pump 92 evacuates each of the second vacuum chamber 52 to the fourth vacuum chamber 54 at a predetermined flow rate so as to have a higher degree of vacuum.

The vacuum pipe 7 connects the vacuum chamber 50 and the vacuum pump 9. The small vacuum gauge 1 measures the degree of vacuum of the vacuum chamber 50. The small vacuum gauge 1 is installed in the vacuum chamber 50 and/or the vacuum pipe 7. More specifically, the small vacuum gauge 1 may be attached to at least one of the first vacuum chamber 51 to the fourth vacuum chamber 54, or may be attached to at least one of the vacuum pipes 7 connecting each of the first vacuum chamber 51 to the fourth vacuum chamber 54 and the inlet of the corresponding vacuum pump 9. When the small vacuum gauge 1 is installed in the vacuum pipe 7, compared to the case where it is arranged in the vacuum chamber 50, the influence of temperature described later and the influence of malfunction during maintenance of the ion guide can be reduced.

### Configuration of Small Vacuum Gauge

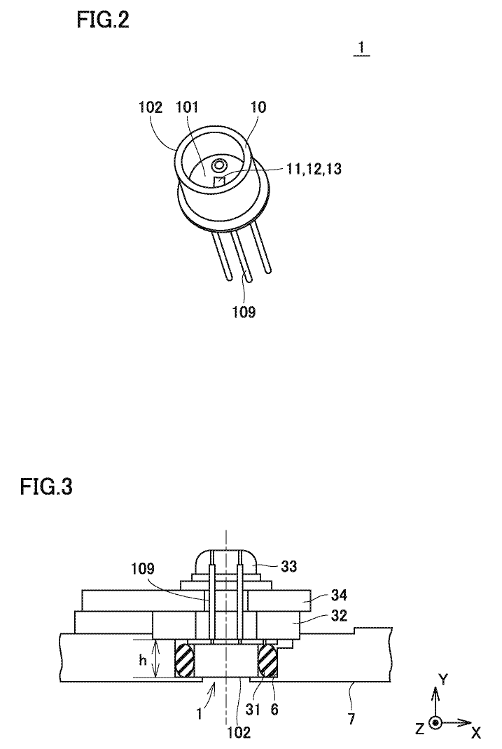

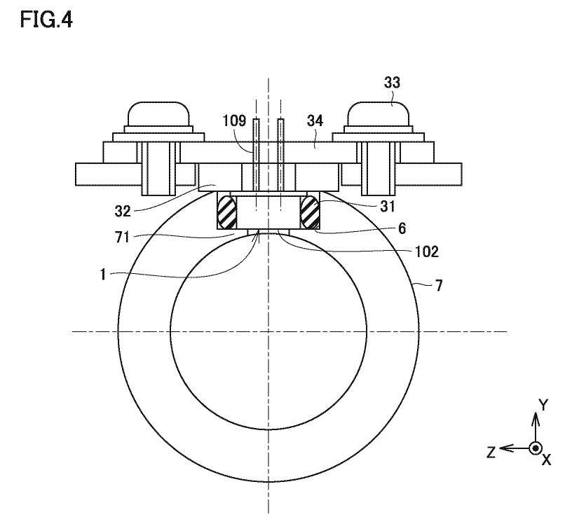

FIG. 2 is a view of the small vacuum gauge 1 before being installed in the vacuum chamber 50 or the vacuum pipe 7, viewed from obliquely above. FIGS. 3 to 4 are installation examples of the small vacuum gauge 1. FIGS. 3 to 4 illustrate a case where the small vacuum gauge 1 is installed on the vacuum pipe 7 (more specifically, the wall of the vacuum pipe 7), but it can be similarly installed on the vacuum chamber 50. In FIGS. 3 to 4, the extending direction of the vacuum pipe 7 is defined as the X direction, the extending direction of the leg portion 109 of the small vacuum gauge 1 is defined as the Y direction, and the direction perpendicular to the XY directions is defined as the Z-axis direction. Referring to FIG. 3, the Y-axis negative direction side with respect to the wall of the vacuum pipe 7 is the inside of the vacuum pipe 7 and is a vacuum environment. The Y-axis positive direction side with respect to the wall of the vacuum pipe 7 is the outside of the vacuum pipe 7 and is an atmospheric environment side. FIG. 3 is a cross-sectional view of the structure around the small vacuum gauge 1 in the XY plane. FIG. 4 is a cross-sectional view of the structure around the small vacuum gauge 1 in the YZ plane.

Referring to FIGS. 2 to 4, the small vacuum gauge 1 includes a CAN package 10, a substrate 12, a sensor 11, and an electronic circuit 13.

The CAN package 10 is a cylindrical package. The CAN package 10 includes a bottom portion 101 constituting the bottom of the cylinder, and a wall portion 102 surrounding the bottom portion 101. The CAN package 10 also includes leg portions 109 provided on the surface of the bottom portion 101 where the substrate 12 is not installed. After the CAN package 10 is installed in the vacuum chamber 50 or the vacuum pipe 7, unnecessary portions of the leg portions 109 may be cut off.

The substrate 12 is accommodated in the CAN package 10. The sensor 11 is a sensor installed on the substrate 12 for measuring the degree of vacuum, and corresponds to an example of a "vacuum degree sensor." In one example, the sensor 11 is a sensor that measures the degree of vacuum using a thermocouple. A sensor that measures the degree of vacuum using a thermocouple has high durability and high reliability because it does not use a platinum wire that is easily broken like a Pirani gauge. Further, since there is no need to replace the platinum wire, maintenance effort is not required. The small vacuum gauge 1 is, for example, TPM227 manufactured by Kodenshi Corp.

In one example, the substrate 12 is installed on the bottom portion 101 of the CAN package 10. Configured in this way, the sensor 11 is protected from the surroundings by the wall portion 102.

In one example, the sensor 11 and the electronic circuit 13 are formed on the substrate 12 using (MEMS: Micro Electro Mechanical Systems) technology. The sensor 11 is connected to the electronic circuit 13. The electronic circuit 13 is connected to the leg portions 109 provided on the opposite side via the bottom portion 101. The output value (voltage value) of the sensor 11 is output to the outside via the electronic circuit 13 and the leg portions 109. By using MEMS technology, miniaturization of the small vacuum gauge 1 is made possible.

The size of the small vacuum gauge 1 is relatively small, specifically, for example, 10 mm or less. As an example, if the height of the wall portion 102 of the small vacuum gauge 1 (h in FIG. 3, hereinafter also referred to as "length of the small vacuum gauge") is 10 mm or less, it is equal to or less than the radial height of other parts (for example, parts for joining pipes together) arranged on the outer periphery of the vacuum chamber 50 or the vacuum pipe 7, so that miniaturization of the analysis apparatus 100 is easy.

As another example, if the diameter of the small vacuum gauge 1 is 10 mm or less, the area occupied on the outer peripheral surface of the vacuum chamber 50 or the vacuum pipe 7 is small, so there is no need to configure the outer peripheral surface of the vacuum chamber 50 or the vacuum pipe 7 to be large, and miniaturization of the analysis apparatus 100 becomes easy. For example, in the examples of FIGS. 3 to 4, a hole 6 into which the wall portion 102 of the small vacuum gauge 1 and the O-ring 31 are fitted is formed in the wall surface of the vacuum pipe 7, but if a larger vacuum gauge is installed in the hole 6, problems arise such as the O-ring 31 not fitting, or the vacuum gauge itself not fitting into the hole 6 in the first place.

In one example, the size of the small vacuum gauge 1 is an IC size (diameter about 5 mm × height 3 mm).

In one example, the small vacuum gauge 1 is installed on the vacuum pipe 7 via an O-ring 31. Since the wall portion 102 of the CAN package 10 is cylindrical, it can be stably held in a state of being fitted into the O-ring. Therefore, the wall portion 102 of the CAN package 10 can be stably installed in a circular opening via the O-ring. In the example of FIG. 3, the wall portion 102 of the small vacuum gauge 1 is fitted into the hole 6 formed in the vacuum pipe 7, and the O-ring 31 is installed so as to fill the gap between the hole 6 and the wall portion 102. Thereby, the space between the hole 6 and the wall portion 102 is sealed. Even when the small vacuum gauge 1 is installed in the vacuum chamber 50 via the O-ring 31, the O-ring 31 is similarly installed so as to seal the space between the hole formed in the vacuum chamber 50 and the wall portion 102.

The inventors verified through actual experiments that there is no problem in airtightness and pressure measurement even if the small vacuum gauge 1 is installed on the wall surface (curved surface) of the cylindrical vacuum pipe 7. Specifically, the inventors calculated an appropriate diameter and compression amount (crush allowance) of the O-ring with respect to the diameter of the hole 6 of the vacuum pipe 7 and the tolerance of the diameter, performed airtightness and pressure measurement using the selected O-ring, and proved that there was no problem with the measured values.

The small vacuum gauge 1 is arranged in an orientation such that the sensor 11 is located on the vacuum environment side and the leg portions 109 are located on the atmospheric environment side. In the examples of FIGS. 3 to 4, the leg portions 109 are connected to the electronic circuit of the substrate 34 on the atmospheric environment side. Thereby, the output value (voltage value) of the sensor 11 is input to the data processing circuit (for example, a computer) via the electronic circuit 13, the leg portions 109, and the electronic circuit of the substrate 34, and is converted into a measurement value in the data processing device. The measurement value is pressure (atmospheric pressure). The substrate 34 is, for example, an FR4 (Flame Retardant Type 4) substrate. The substrate 34 is fixed to the vacuum chamber 50 or the vacuum pipe 7 by screws 33. In the examples of FIGS. 3 to 4, by providing a spacer 32 between the substrate 34 and the vacuum pipe 7, the planar substrate 34 is easily arranged stably on the curved surface of the vacuum pipe 7. In another example, instead of providing the spacer 32, a flat portion may be provided on the vacuum pipe 7, and the sensor 11 may be installed on the flat portion.

As a device by the inventors when installing the small vacuum gauge 1, the small vacuum gauge 1 is pressed by the spacer 32 (or the substrate 34 if the spacer 32 is absent) so as not to move to the outside of the vacuum pipe 7. For this reason, a holding portion 71 is formed on the inner wall surface of the vacuum pipe 7 so that the small vacuum gauge 1 does not move to the inside of the vacuum pipe 7, but there is no need to form a holding portion on the outer wall surface. This makes the processing of the vacuum pipe 7 easier than in the case where a holding portion is also formed on the outer wall surface. Further, the small vacuum gauge 1 can be installed on the vacuum pipe 7 having a thinner wall than in the case where a holding portion is formed on the outer wall surface.

### Comparison with Pirani Gauge According to Comparative Example

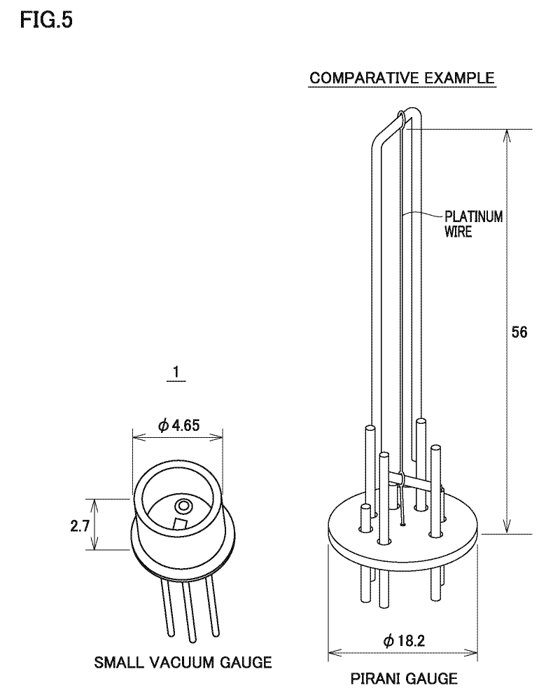

FIG. 5 is a diagram for explaining the sizes of each of the small vacuum gauge 1 according to the embodiment and a Pirani gauge according to a comparative example. In this specification, when simply "Pirani gauge" is described, it refers to a Pirani gauge of a structure and size conventionally used for pressure measurement, as illustrated in the following comparative example. Note that the Pirani gauge of the structure and size conventionally used for pressure measurement and a micro Pirani vacuum gauge described later are different in structure from each other, but both are vacuum gauges that measure the degree of vacuum by utilizing the fact that the current value flowing through the Pirani wiring changes when gas molecules collide while current is flowing through the Pirani wiring, so they are collectively referred to as "Pirani vacuum gauges."

The size ratio between the small vacuum gauge 1 and the Pirani gauge in FIG. 5 differs from the actual size ratio. In one example, the size of the small vacuum gauge 1 is 4.65 mm in diameter and 2.7 mm in length. On the other hand, the size of the Pirani gauge according to the comparative example is 18 mm in diameter and 56 mm in length. Compared to the small vacuum gauge 1 according to the present embodiment, the Pirani gauge according to the comparative example is 3.9 times or more in diameter and 20.7 times or more in length. In other words, the small vacuum gauge 1 according to the present embodiment is downsized by more than 74% in diameter and more than 95% in length compared to the Pirani gauge according to the comparative example. Further, the Pirani gauge usually requires a casing that accommodates the platinum wire and a hermetic seal in order to protect the platinum wire. The size of the Pirani gauge including the casing becomes larger than the size of the Pirani gauge itself, which is about 2 cm in diameter and about 6 cm in length, described above.

When installing a Pirani gauge in an analysis apparatus, a relatively expensive component, a hermetic seal, is required to ensure electrical connection between the platinum wire (Pirani wiring) and the outside (atmospheric environment) while maintaining the airtightness of the installation part. In addition, spot welding is required to connect the hermetic seal and the Pirani gauge, which causes an increase in the cost of the Pirani gauge.

Furthermore, when the Pirani gauge also includes a casing, airtight welding is required for the connection between the casing and the analysis apparatus, which also causes an increase in cost when using the Pirani gauge.

Furthermore, when installing the Pirani gauge in the main body of the analysis apparatus, it is necessary to install the opening surface of the casing parallel to the ion beam so that ion flow, gas flow, etc. do not collide with the platinum wire. Also, in order to maintain the measurement accuracy of the Pirani gauge, it is necessary to install it avoiding the hot parts of the main body. Furthermore, since the platinum wire is very thin (for example, about 25 μm in diameter) and easily broken by mechanical impact, it is necessary to install it in a recessed place where there is no risk of accidental contact during maintenance of the main body.

In addition, in a mass spectrometer, the degree of vacuum of the first vacuum chamber is generally measured, but a gas flow containing ions formed by the differential pressure between both ends of the desolvation tube is generated in the first vacuum chamber. Therefore, it is necessary to install the Pirani gauge at a position and in a direction where the gas flow of the first vacuum chamber does not collide with the platinum wire.

Further, since the desolvation tube is heated to several hundred degrees, the heat is transmitted to the first vacuum chamber through the housing (generally made of metal). Also, a part of the heat is transmitted to the first vacuum chamber by the gas flow described above. In addition, since the set temperature of the desolvation tube and the set temperature of the ESI probe with heating assist gas are both parameters that can be set by the user, the way heat is transmitted to the first vacuum chamber differs depending on the settings. Therefore, it is necessary to install the Pirani gauge at a position not affected by temperature changes.

Furthermore, since the ion guide of the first vacuum chamber is a component that the user maintains by themselves, it is necessary to install the Pirani gauge so that it is not accidentally touched by erroneous operation during maintenance of the ion guide of the first vacuum chamber.

As described above, the Pirani gauge has a relatively large size and its installation position is limited, which hinders the miniaturization of the main body of the analysis apparatus. Relatedly, it is necessary to form the housing of the main body into a complicated shape, which causes an increase in cost.

Also, when installing a Pirani gauge in the vacuum pipe connecting the main body and the vacuum pump, since the Pirani gauge is relatively long in the radial direction of the vacuum pipe (about 6 cm including the hermetic seal), dead volume is generated, hindering the miniaturization of the device.

For example, in a mass spectrometer, even when trying to arrange another unit (for example, a power supply unit) next to the vacuum pipe, a gap corresponding to the length of the Pirani gauge is created between the vacuum pipe and the power supply unit.

As described above, analysis apparatuses including conventional analysis apparatuses with Pirani gauges have problems that the cost is high and miniaturization is difficult due to the characteristics of the size and structure of the Pirani gauge.

On the other hand, according to the analysis apparatus 100 relating to the present embodiment, cost reduction and miniaturization are possible.

First, the small vacuum gauge 1 itself is a fraction to one-several tenths of the size of the Pirani gauge and does not take up space. Relatedly, due to its small size, the installable range is wide when attaching to the analysis apparatus 100. And the shape of the hole 6 opened in the installation part may be a small and simple shape.

Further, in the small vacuum gauge 1, since the sensor 11 is accommodated in the CAN package 10, even when installed in the vacuum chamber 50, there is no need to consider preventing ion flow and gas flow from interfering with the measurement value of the sensor, or preventing accidental impact on the sensor 11 during maintenance. Therefore, there is no need to process the housing into a complicated shape, and the installable range is further expanded.

Also, when installing the small vacuum gauge 1 in the vacuum pipe 7, the dead volume around the installation part is reduced, and the layout of other units in the analysis apparatus becomes more free, which also facilitates miniaturization of the analysis apparatus 100.

Furthermore, since the small vacuum gauge 1 is held by the inexpensive O-ring 31 and substrate 34, a casing for holding the vacuum gauge and a hermetic seal, as in the Pirani gauge, are unnecessary. Thereby, when using the small vacuum gauge 1, the sealed state of the installation part can be maintained at low cost without using expensive spot welding and airtight welding.

Note that the small vacuum gauge 1 can also be installed in the vacuum chamber 50 or the vacuum pipe 7 by other methods such as soldering, brazing, welding, bonding, etc., but from the viewpoint of reducing cost and effort, installation with an O-ring is preferable.

As described above, according to the analysis apparatus 100, it is possible to provide an analysis apparatus capable of measuring the degree of vacuum of the vacuum chamber and capable of miniaturization.

Therefore, the mass spectrometer including the small vacuum gauge 1 according to the present embodiment can be manufactured smaller and cheaper than a mass spectrometer using a general Pirani gauge according to the comparative example. Relatedly, since the vacuum chamber 50 can be configured to be small, the evacuation time can be shortened, and user convenience is improved. This makes it easier for users who have found it difficult to use mass spectrometers until now to obtain them, expanding the possibility of performing mass spectrometry in new fields.

However, conventionally, in analysis apparatuses such as mass spectrometers, since Pirani gauges have been used exclusively for measuring the degree of vacuum, a conversion formula (output equation) for converting the output value of the small vacuum gauge 1 into pressure in the analysis apparatus has not been prepared. Therefore, the inventors created output equations as shown in the following examples in order to obtain measurement values closer to the true degree of vacuum in the analysis apparatus.

### Output and Individual

Difference Correction of Small Vacuum Gauge] In this example, TPM227 manufactured by Kodenshi Corp. was used as the small vacuum gauge 1.

The inventors derived output equations and performed calibration for each individual small vacuum gauge 1 as follows in order to obtain measurement values closer to the true degree of vacuum when using the small vacuum gauge 1, and to reduce individual differences in measurement values of the degree of vacuum.

In this specification, the conversion formula for converting the output value of the vacuum gauge into pressure (atmospheric pressure) is also referred to as "output equation." Note that both the output value of the Pirani gauge and the output value of the small vacuum gauge 1 are voltage values.

While the output equation of a conventional Pirani gauge is expressed by a single equation, it is difficult to express the output equation of the small vacuum gauge 1 by a single equation. Therefore, the inventors divided the necessary pressure range into a plurality of pressure sections and derived output equations. For the derivation of the output equations, equations assumed for each pressure section (parameter values undetermined) and known measurement values were used, and the parameter values were optimized and determined by the least squares method. By using the output equations, measurement values close to the true degree of vacuum can be obtained.

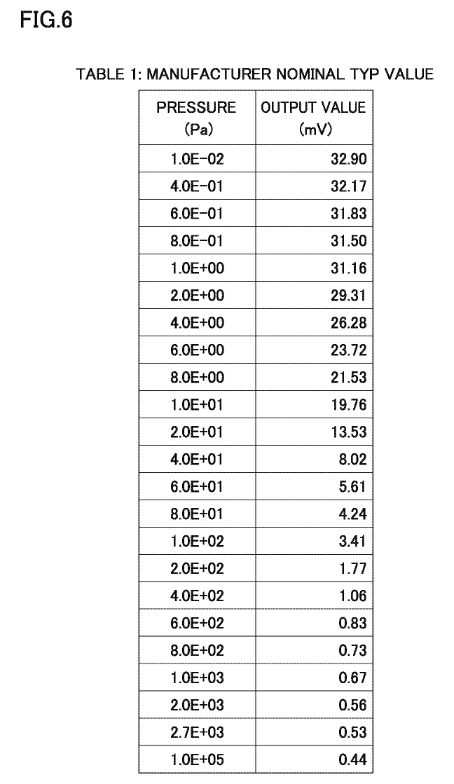

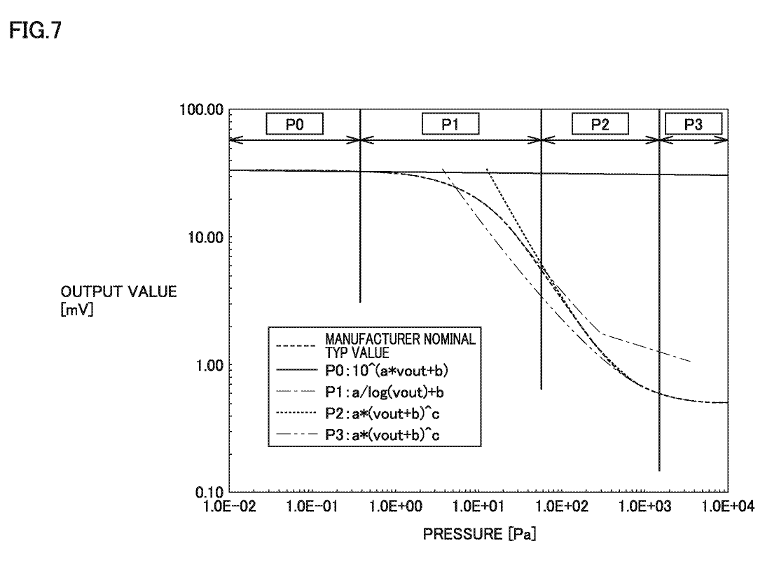

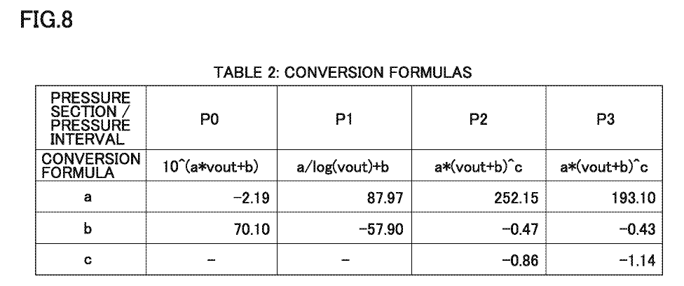

Specifically, the inventors obtained a table of TYP values of the small vacuum gauge (FIG. 6) from the manufacturer. Then, the relationship between the output value and pressure in FIG. 6 was represented as "Manufacturer Nominal TYP Value" in the graph of FIG. 7. Next, based on the trend of the graph in FIG. 7, the inventors divided the necessary pressure range into four pressure sections P0 to P3. Then, the inventors performed least squares approximation for each pressure section and created output equations. FIG. 8 is a table showing the values of the parameters of the output equation for each pressure section.

Next, the inventors confirmed whether the measurement values of a plurality of small vacuum gauges 1 obtained using the output equations matched the actual pressure (atmospheric pressure) measured using a Pirani gauge. In other words, the inventors verified whether the measurement values of the small vacuum gauge 1 and the measurement values of the Pirani gauge matched in the pressure range where measurement is required.

As a result, regarding the pressure range where measurement is required, it was found that the measurement values of the plurality of small vacuum gauges 1 matched the measurement values of the Pirani gauge. However, the inventors found that in a part of the pressure range (low pressure range), the required accuracy could not be satisfied due to variations in output values for each individual small vacuum gauge 1. Therefore, by performing measurement with the Pirani gauge and the small vacuum gauge 1 for one point (one pressure) in the low pressure range, and multiplying the output equation by the deviation rate of the measurement value of the small vacuum gauge relative to the measurement value of the Pirani gauge as a correction coefficient, it was experimentally verified that the required accuracy could be satisfied even in the low pressure range. By this correction method, individual differences in vacuum degree values can be reduced, and pressure can be measured with necessary accuracy even in the low pressure range.

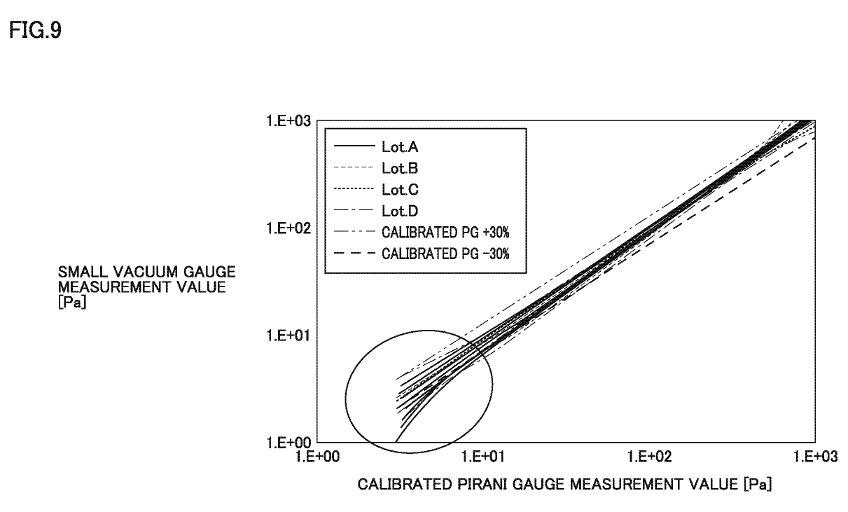

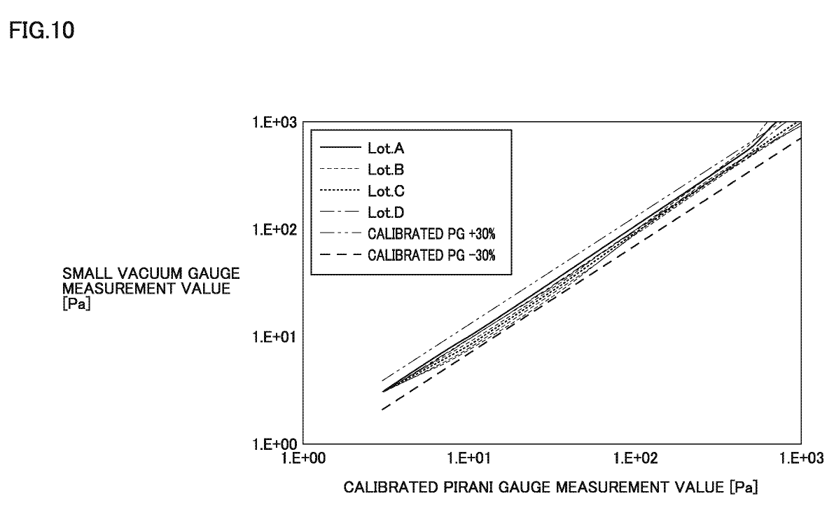

Specifically, the inventors compared the measurement values of small vacuum gauges 1 of four types of Lots, Lot A to Lot D, and the measurement values of the Pirani gauge (FIG. 9). In FIG. 9, in most pressure ranges, the measurement values of all small vacuum gauges 1 fall within the target accuracy range (inside the two target accuracy lines), but as indicated by the circle, in the low pressure range of 10 Pa or less, the measurement values of some small vacuum gauges fell outside the target accuracy range. In the example of FIG. 9, the target accuracy range is a range of ±30% with respect to the measurement value of the Pirani gauge in the pressure range of 1 to 300 Pa. Therefore, in the low pressure range of 10 Pa or less, calibration was performed by multiplying the output equation by the deviation rate from the pressure of the TYP value as a correction coefficient. By this calibration, as shown in FIG. 10, the measurement values of the small vacuum gauge 1 fell within the target accuracy range.

According to the method for deriving the output equations described above, the degree of vacuum in the medium vacuum region of a mass spectrometer, ion analyzer, etc., can be measured with a correct value. Further, if the correction method for the measurement value described above is used in combination, individual differences of the small vacuum gauge 1 can be reduced, and a more correct degree of vacuum can be measured.

### Other Aspects

A micro Pirani sensor may be used as the sensor of the small vacuum gauge 1. A micro Pirani sensor is a sensor that is fabricated on a substrate using MEMS technology and measures the degree of vacuum using minute Pirani wiring. As the minute Pirani wiring, for example, a minute titanium wire is used. In other words, the small vacuum gauge 1 is a small Pirani vacuum gauge created using MEMS technology. More specifically, the small vacuum gauge 1 may be a micro Pirani vacuum gauge in which a micro Pirani sensor is accommodated in a CAN package using MEMS technology. Like the small vacuum gauge that measures the degree of vacuum with a thermocouple, the micro Pirani vacuum gauge has advantages over the Pirani gauge, such as enabling miniaturization of the main body of the analysis apparatus and having a low possibility of being accidentally touched during maintenance.

As the package of the small vacuum gauge 1, instead of the CAN package 10, other small packages (for example, packages used in the PVC3000 series of POSIFA) may be used.

As the package of the small vacuum gauge 1, a self-made package may be used, but using a commercially available CAN package 10 saves the trouble and cost of creating a package.

Also, a rectangular package may be used, but a cylindrical package is superior in that drilling for installation is easy and sealing with an O-ring is also easy. However, when using a small vacuum gauge with a short length (h in FIG. 3), it is also possible to attach the small vacuum gauge with a face seal.

Furthermore, in the small vacuum gauge 1, instead of a package, a small sensor may be provided on a small plate-like member using MEMS technology.

Similarly, as the small vacuum gauge 1, one in which a micro Pirani sensor is arranged in a small package other than a CAN package, or one arranged on a small plate-like member may be used; for example, the PVC3000 series of POSIFA or PVC4101 of POSIFA may be used.

### Aspects

It is understood by those skilled in the art that the plurality of exemplary embodiments described above are specific examples of the following aspects.

(Item 1) An analysis apparatus according to one aspect includes: an ionization unit that generates ions by ionizing a sample; a vacuum chamber into which the ions are introduced and an inside of which is maintained at a vacuum; a detector that detects the ions; and a small vacuum gauge that measures a degree of vacuum of the vacuum chamber. The small vacuum gauge includes a cylindrical CAN package, a substrate accommodated in the CAN package, and a vacuum degree sensor formed on the substrate.

According to the analysis apparatus described in Item 1, it is possible to provide an analysis apparatus capable of measuring the degree of vacuum of a vacuum chamber and capable of miniaturization.

(Item 2) In the analysis apparatus according to Item 1, the size of the small vacuum gauge is 10 mm or less.

According to the analysis apparatus described in Item 2, the size is a fraction to one-several tenths of that of a Pirani gauge, and it does not take up space. Relatedly, due to its small size, the installable range is wide when attaching to the analysis apparatus. And the shape of the hole opened in the installation part may be a small and simple shape.

(Item 3) In the analysis apparatus according to Item 1 or 2, the small vacuum gauge measures the degree of vacuum by a thermocouple.

(Item 4) In the analysis apparatus according to any one of Items 1 to 3, the small vacuum gauge is a small Pirani vacuum gauge created using MEMS technology.

(Item 5) In the analysis apparatus according to any one of Items 1 to 4, the small vacuum gauge is installed in the vacuum chamber via an O-ring.

According to the analysis apparatus described in Item 5, the space between the hole formed in the vacuum chamber and the small vacuum gauge can be sealed using the O-ring.

(Item 6) The analysis apparatus according to any one of Items 1 to 5 further includes a vacuum pump that evacuates the vacuum chamber, and a vacuum pipe connecting the vacuum chamber and the vacuum pump. The small vacuum gauge is installed in the vacuum pipe via an O-ring.

According to the analysis apparatus described in Item 6, the space between the hole formed in the vacuum pipe and the small vacuum gauge can be sealed using the O-ring.

(Item 7) The analysis apparatus according to any one of Items 1 to 6 is a mass spectrometer.

The mass spectrometer described in Item 7 can be manufactured smaller and cheaper than a mass spectrometer using a general Pirani gauge.

The embodiments disclosed this time should be considered as illustrative in all respects and not restrictive. The scope of the present invention is indicated by the claims rather than the above description, and is intended to include all modifications within the meaning and range of equivalency of the claims.

### REFERENCE SIGNS LIST

1 Small vacuum gauge, 5 Main body, 6 Hole, 7 Vacuum pipe, 9 Vacuum pump, 10 CAN package, 11 Sensor, 12, 34 Substrate, 13 Electronic circuit, 31 O-ring, 32 Spacer, 33 Screw, 50 Vacuum chamber, 51 First vacuum chamber, 52 Second vacuum chamber, 53 Third vacuum chamber, 54 Fourth vacuum chamber, 55 Detector, 57 Desolvation tube, 58 ESI probe, 59 Ionization chamber, 91 Rotary pump, 92 Turbo molecular pump, 100 Analysis apparatus, 101 Bottom portion, 102 Wall portion, 109 Leg portion, 511, 521, 531 Ion guide, 512 Skimmer, 541 Quadrupole mass filter.

1. An analysis apparatus comprising: an ionization unit that generates ions by ionizing a sample; a vacuum chamber into which the ions are introduced and an inside of which is maintained at a vacuum; a detector that detects the ions; and a small vacuum gauge that measures a degree of vacuum of the vacuum chamber, wherein the small vacuum gauge includes: a cylindrical CAN package; a substrate accommodated in the CAN package; and a vacuum degree sensor formed on the substrate.

2. The analysis apparatus according to claim 1, wherein a size of the small vacuum gauge is 10 mm or less.

3. The analysis apparatus according to claim 1, wherein the small vacuum gauge measures the degree of vacuum by a thermocouple.

4. The analysis apparatus according to claim 1, wherein the small vacuum gauge is a small Pirani vacuum gauge created using MEMS technology.

5. The analysis apparatus according to claim 1, wherein the small vacuum gauge is installed in the vacuum chamber via an O-ring.

6. The analysis apparatus according to claim 1, further comprising: a vacuum pump that evacuates the vacuum chamber; and a vacuum pipe connecting the vacuum chamber and the vacuum pump, wherein the small vacuum gauge is installed in the vacuum pipe via an O-ring.

7. The analysis apparatus according to claim 1, wherein the analysis apparatus is a mass spectrometer.
